(19) United States
(12) Patent Application Publication
(10) Pub. No.: US 2016/0215159 A1
(43) Pub. Date: Jul. 28, 2016

(54) PROTECTIVE FILM COMPOSITION FOR LASER DICING AND USE THEREOF

(71) Applicant: GTA Electronics Co., Ltd., New Taipei City (TW)

(72) Inventors: Yung-Chi TSAI, New Taipei City (TW); Shu-Man TSENG, New Taipei City (TW); Jia-Huet LIN, New Taipei City (TW)

(21) Appl. No.: 14/604,104

(22) Filed: Jan. 23, 2015

(51) Int. Cl. C09D 129/04; C08K 5/00; C08K 3/00

(52) U.S. Cl. CPC C09D 129/04; C08K 3/0008; C08K 5/0008

(57) ABSTRACT

A protective film composition for laser dicing is provided, which includes: a water-soluble polymer and a crosslinking agent. Wherein, a weight-average molecular weight of the water-soluble polymer is 10000-150000, and is optimally, 12500-125000. The crosslinking agent is added to enable the functional groups of the water-soluble polymer generating a crosslinking reaction, and the water-soluble polymer therefore has a higher thermal stability. When applying to manufacturing process of laser dicing, a substrate can be protected from being stained with dust and the pollution problem of the substrate can be reduced. In addition, as the thermal stability of the protective film is increased, the stability of the protective film is enhanced and thus is not easy to become weak, and the cutting ways would be evener during the process of laser dicing.

### BACKGROUND OF THE INVENTION

1. Field of the Invention

The present application relates to a protective film composition for laser cutting, and more particularly, to a protective film applied to a manufacturing process involving laser dicing.

2. Description of the Related Art

Semiconductor wafer is of laminated structure and includes interlayer insulation film and functional film stacked on the semiconductor substrate (i.e. silicone). In the process of cutting wafer, various circuits are implemented and formed on the substrate, and after surface treatment followed by partition (e.g. cutting) of the semiconductor substrate, small pieces of components (i.e. semiconductor components . . . etc.) are manufactured. Wherein, the partition process indicates that the wafer is cut along the boundary region of a street thereof to separate the electronic components disposed respectively so as to achieve the purpose of the manufacturing process. However, as the precision requirement of cutting increase due to increasing integration of the semiconductor device and narrowing width of the street, technical problem of the thermal effect (cutting ways break up and fragment due to heat) has become a bottleneck of the laser dicing process.

Wafer's cutting process is revolutionized from using blade to the current laser dicing process. The laser dicing process comprises applying laser beam along the street to thereby form a groove corresponding to the width of the cutting edge of the cutting blade, and then cutting the wafer by the blade. However, the generated thermal energy is absorbed by the wafer when the laser beam irradiating along the street, resulting in that the thermal energy is accumulated on the wafer so that the technical problem of the cutting process is therefore inevitable. In addition, as the uppermost of wafer's laminated structure is an insulating film which mainly comprising polyimide and is easy to break up or to be damaged in the wafer's laser dicing process. The thermal energy leads the wafer's substrate to silicon melting or thermal decomposition easily, and silicon vapor is hence generated, condensed and deposited on the surface of the wafer. As a result, when cutting a wafer, the protective film may break up easily provided that the wafer's protect film lacks for heat resistance. Accordingly, the sputters generated during cutting the wafer may permeate the gap of the broken film. Moreover, as the sputters are not water-soluble, it may become a defect for the wafer that the sputters are not able to be removed by washing through water when they attach on surface of the wafer.

Recently, the wafer's cutting process has developed to laser dicing process because of its precise cutting method, and the laser dicing process may have less thermal damage to the wafer and is applicable to implement a high-precision process. Even though the method is applied, the heat generated by laser beam may cause wafer's insulating film forming adverse laminates. Additionally, fume of silicon vapor generated by the heat may be accumulated between surfaces of the insulating film and the wafer in the laminated status. When cleaning the insulating film of the wafer, the fumed deposition may not be removed so as to become a defect, and thus results a problem of pollution on the upper surface of the wafer.

The prior art used to resolve the technical problem, such as TW 200631086 A, disclosed a protective film agent for laser dicing comprising a solution, in which is dissolved a water-soluble resin and at least one water-soluble laser light absorption agent selected from the group consisting of a water-soluble dye, a water-soluble coloring agent and a water soluble ultraviolet absorbent. It mainly coats water-soluble resins such as polyvinyl alcohol, polyethylene glycol or celluloses . . . etc. on the wafer's surface to form a protective film, and then a laser beam is applied to perform cutting process. As a result, the wafer's surface may be protected by the protective film, and even the residues such as thermal decomposition products produced by silicon vapor or substrate being affected under laser irradiation may only be spread, condensed or deposited on the protective film's surface without depositing on wafer's surface. Furthermore, the protective film is water-soluble and easy to be removed by water. That is, when the protective film is cleaned by water, the residues on the protective film can be cleaned simultaneously.

In addition, a patent of TW 1399402 disclosed a protective film composition for wafer dicing comprising at least one resin selected from the group consisting of polyethyloxazoline and polyvinylpyrrolidone, at least one component selected from the group consisting of a water-soluble resin and an alcoholic monomer, and a solvent, such as water or a mixture of water and an organic solvent. Consequently, the protective film composition for wafer dicing has higher thermal stability and is able to avoid producing thermal decomposed crosslinking materials under the laser irradiation in the dicing process. The protective film composition for wafer dicing also shows high adhesion force to the wafer to prevent the protective film from being delaminated in the laser dicing process. Moreover, the protective film composition may be formed with an adequate hardness, thus, it is away from the problem of breaking up during the dicing process.

However, the aforementioned two methods both use water-soluble resin, which is usually of worse thermal stability. The protective film composition may generate internal heat when the wafer is under laser irradiation during the laser dicing process. If the used water-soluble resin lacks of enough molecular weight, it may have thermal decomposition as suffers from heat and have limited protection to the substrate.

As a result, how to develop a protective film composition having higher thermal stability and being able to avoid the thermal decomposition generated by laser irradiation in the dicing process has become an urgent to-be-resolved technical problem in terms of the current wafer manufacturing industry.

### SUMMARY OF THE INVENTION

Inasmuch as the deficiency of the prior art, the inventor of the present invention has been mulling it over and hence develops a protective film composition for laser dicing.

In order to achieve to the aforementioned purpose, an embodiment of the present invention provides a protective film composition for laser dicing which may include a water-soluble polymer and a crosslinking agent, and wherein a weight-average molecular weight of the water-soluble polymer may be 5000-150000, and may be optimally, 12500-125000. By adding the crosslinking agent to enhance the degree of crosslinking between the macromolecules, the protective film composition for laser dicing in accordance with an embodiment of the present invention may have a higher thermal stability while the protective film is cut by laser beam. As the protective film composition may be coated by a water-soluble resin having lower molecular weight, thus, the apparatus is easy to be cleaned and the coating is more even, and the strength of the protective film is thereby maintained in the laser dicing process.

A protective film composition in accordance with an embodiment of the present invention may be coated on a to-be-processed wafer's surface, and the formed thickness may be usually in a range from 100 to 5000 nm, and may be optimally, in a range from 500 to 1500 nm. Because the added crosslinking agent may enhance the degree of crosslinking between the macromolecules, weight-average molecular weight of the used water-soluble polymer may be a minimum of 5000. In addition, when the protective film composition for laser dicing uses the macromolecules with a higher molecular weight, a greater amount of solvents is necessary to the composition. However, it may cause that the coating thickness becomes uneven easily after the solvents are vapored as the coating cured during the coating process.

Wherein, a molecular structure of the water-soluble polymer may include a hydrophilic group selected from the group consisting of hydroxyl group, oxyethyl group, amide group, amino group, sulfo group, sulfinic acid group, carboxyl group and carbonyl group.

According to one embodiment of the present invention, the water-soluble polymer may be selected from the group consisting of polyethylene glycols, polypropylene glycols, polyethylene oxides, polypropylene oxides, polyether esters, polyvinyl alcohols, sodium polyacrylates, poly acrylamides, polyvinyl pyrrolidones, carboxymethyl cellulose and polytetramethylene glycols.

Wherein, the crosslinking agent may be selected from the group consisting of isocyanate-based crosslinking agent, melamine-based crosslinking agent, epoxy-based crosslinking agent, acrylate-based crosslinking agent or methacrylate comprising isocyanate-group.

Wherein, the crosslinking agent may be 0.1-10 parts by weight based on 100 parts by weight of the water-soluble polymer, and preferably, may be 1-5 parts by weight. Water solubility may become worse when the crosslinking agent is added overly, and it may hence need to remove the protective film by a hot water cleaning apparatus.

Wherein, the composition may further including an additive selected from the group consisting of surfactant, defoaming agent, levelling agent and solvent. Wherein, the surfactant may be 0.01-5 parts by weight and may be a non-ionic or anionic surfactant selected from the group consisting of polyoxyethylenes, polyoxyethylene ethers, sorbitol, sorbitan esters, polyethers, aliphatic alcohol alkoxys, stearic acids, sulfonic acids, carboxylic acids and phosphates, in which may be used individually or in combination. Wherein, the defoaming agent may be selected from the group consisting of methyl ethers, polyether esters, propylene glycols, ethylene oxide and propylene oxide polymers, lower alcohols and higher alcohols, in which may be used individually or in combination. Wherein, the levelling agent may be 0.1-5 parts by weight, and may be selected from the group consisting of polyoxyethylene ethers, alcoholic ethers, acetates, acrylic acids, acrylate esters, phenyl methyl ketones and hydroxyl groups, in which may be used individually or in combination. Wherein the solvent may be 5-30 parts by weight and may be selected from the group consisting of ethers, lower alcohols, propylene glycols, alcoholic ethers and hydroxy acids, in which may be used individually or in combination.

In accordance with another purpose of the present invention, it provides a protective sheet for laser dicing which may include a substrate, and a protective layer formed of the above-mentioned protective film composition for laser dicing coated on the substrate.

A protective film composition in accordance with an embodiment of the present invention may be a liquid coating agent so as to serve as a protective sheet for laser dicing. A protective film composition in accordance with an embodiment of the present invention may be coated and formed on a surface of a substrate in advance, followed by being attached on wafer's surface via an adhesive layer so as to serve as a protective sheet for laser dicing. A protective film composition in accordance with an embodiment of the present invention may be attached on wafer's surface without the adhesive layer when using a water-soluble polymer having better adhesion ability so as to serve as a protective sheet for laser dicing.

A protective film is formed by coating the protective film composition for laser dicing in accordance with an embodiment of the present invention on a to-be-processed wafer's surface, for example, the wafer's surface has formed with semiconductor chips partitioned by streets of multiple lattice patterns, and then drying the coating layer. Generally, a thickness of a protective film is ranging from 100-5000 nm, and is optimally, ranging from 500-1500 nm. Since the to-be-processed wafer's surface has many recesses and protrusions, and the streets are formed inside the recesses in which the thickness is too small, the fragments may enter the protective film and deposit on the wafer's surface for that the thickness of the protective film at the protrusions become too small. On the other hand, the unnecessary thickness does not provide any advantages, and it may only lead to a time-consuming cleaning process after the process is completed.

With these and other objects, advantages, and features of the invention that may become hereinafter apparent, the nature of the invention may be more clearly understood by reference to the detailed description of the invention, the embodiments and to the several drawings herein.

### BRIEF DESCRIPTION OF THE DRAWINGS

FIG. 1 is a schematic diagram of a protective sheet for laser dicing of embodiment 3 in accordance with the present invention.

### DETAILED DESCRIPTION OF THE PREFERRED EMBODIMENTS

In order to be fully understood purpose, feature and effect of the present invention, the following will make a detailed explanation to the present invention through the specific embodiment below. The description is stated as follows:

The following is the table used to explain the embodiments of a protective film in accordance with the nresent invention.

| | Embodiment 1 | Embodiment 2 | Comparison 1 | Comparison 2 | Comparison 3 |
|---|---|---|---|---|---|
| | (part by weight) | (part by weight) | (part by weight) | (part by weight) | (part by weight) |
| PVA: molecular weight | 20 | 0 | 20 | 20 | 0 |
| about 13K | | | | | |
| PVA: molecular weight | 0 | 20 | 0 | 0 | 0 |
| about 119K | | | | | |
| PVA: molecular weight | 0 | 0 | 0 | 0 | 20 |
| about 250K | | | | | |
| Glutaraldehyde | 1 | 1 | 0 | 15 | 1 |

Test Result

| | | | | | |
|---|---|---|---|---|---|
| Coating appearance | Even | Even | Even | Even | Uneven |
| | | | | | Wave pattern |
| Water solubility | water soluble | water soluble | water soluble | Non-water | Non-water |
| (within 1 min) | | | | soluble | soluble |
| Silicon deposition | None | None | Trace | None | Trace |

### Embodiment 1

Preparing a protective film aqueous solution comprising the following compositions: Firstly, a water-soluble resin, polyvinyl alcohol (PVA) of 20 g (about 13K of molecular weight), is dissolved in water of 100 ml, and then a crosslinking agent, glutaraldehyde, is added by 1 g. Next, the preceding protective film aqueous solution is coated on a silicon wafer by spin coating, and is dried on the silicon wafer to form a protective film having a thickness of 500-1300 nm. Afterwards, the coated silicon wafer is placed on a laser processing apparatus to be processed by laser beam, and the protective film is removed by pure water when the process is completed and then to observe the surrounding of silicon wafer being processed by laser. No silicon contamination is deposited and the width of the processed interface is similar to the diameter of the laser setting parameter, which shows that it is not affected by the coating of the protective film.

### Embodiment 2

A protective film aqueous solution is prepared with the same part by weight according to Embodiment 1; however, a polyvinyl alcohol with molecular weight of about 119K is selected. The coating method and assessment to the protective film are akin to that of embodiment 1.

The protective film may be cleaned by pure water and does not have silicon deposition. In addition, the width of the processed interface is similar to the diameter of the laser setting parameter.

### Comparison 1

A protective film aqueous solution is prepared with the same part by weight according to Embodiment 1 without adding a crosslinking agent. The coating method and assessment to the protective film are akin to that of embodiment 1. Pure water may be used to remove the protective film, but it is easily to observe that there's silicon deposition at the surrounding of the silicon wafer processed by laser, and that the cutting ways have burning phenomena.

### Comparison 2

A protective film aqueous solution is prepared with the same part by weight according to Embodiment 1, however, a crosslinking agent of 15 g is applied. The coating method and assessment to the protective film are akin to that of embodiment 1. It is not easy to remove the protective film by the usage of pure water with room temperature, however, hot water is necessary. In addition, there are no obvious sintered products and residuals remained on the cutting ways at the surrounding which is processed by laser.

### Comparison 3

A protective film aqueous solution is prepared with the same part by weight according to Embodiment 1, however, the PVA having molecular weight of about 250K is applied. The coating method and assessment to the protective film are akin to that of embodiment 1. It is not easy to remove the protective film by the usage of pure water with room temperature, however, hot water is necessary. In addition, the uneven thickness of the film may cause that the cutting ways become uneven and the amount of sintered products and residuals increases.

### Embodiment 3

A protective film aqueous solution is prepared with the same part by weight according to Embodiment 1 and, and the protective film aqueous solution is coated on a substrate to form a protective sheet for laser dicing.

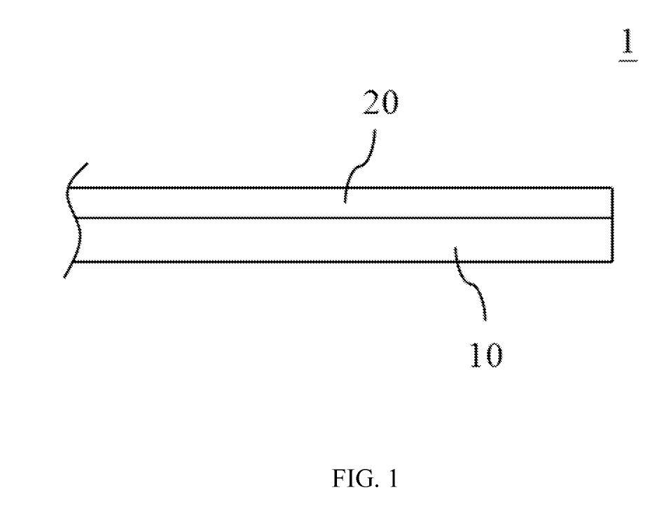

A protective sheet for laser dicing of embodiment 3 is shown in FIG. 1. The protective sheet for laser dicing 1 may include: a substrate 10 and a protective layer 20 formed of the protective film composition for laser dicing coated on the substrate, and wherein protective layer 20 has a thickness ranging from 500 to 1500 nm.

As mentioned above, the present invention fully complies with patentability of novelty, inventiveness and industrial applicability. As far as novelty and inventiveness are concerned, a protective film composition for laser dicing in accordance with the present invention is able to enhance the degree of crosslinking between the macromolecules by adding a crosslinking agent. When the present invention is applied as a protective film for laser dicing, it may have a better thermal stability such that the apparatus may not be contaminated easily in the coating process. Moreover, the strength of the protective film is thereby maintained while being cut by laser. When it comes to industrial applicability, the products made by the present invention may absolutely satisfy the demand for the current market.

While the means of specific embodiments in present invention has been described by reference drawings, numerous modifications and variations could be made thereto by those skilled in the art without departing from the scope and spirit of the invention set forth in the claims. The modifications and variations should in a range limited by the specification of the present invention.

What is claimed is:

1. A protective film composition for laser dicing, comprising:
a water-soluble polymer, and
a crosslinking agent,
wherein a weight-average molecular weight of the water-soluble polymer is 10000-150000.

2. The composition of claim 1, wherein the crosslinking agent is 0.1-10 parts by weight based on 100 parts by weight of the water-soluble polymer.

3. The composition of claim 1, further comprising an additive selected from the group consisting of surfactant, defoaming agent, levelling agent and solvent.

4. The composition of claim 3, wherein the surfactant is a non-ionic or anionic surfactant selected from the group consisting of polyoxyethylenes esters, polyoxyethylene ethers, sorbitol, sorbitan esters, polyethers, aliphatic alcohol alkoxys, stearic acids, sulfonic acids, carboxylic acids and phosphates.

5. The composition of claim 3, wherein the defoaming agent is selected from the group consisting of methyl ethers, polyether esters, propylene glycols, ethylene oxide and propylene oxide polymers, lower alcohols and higher alcohols.

6. The composition of claim 3, wherein the levelling agent is 0.1-5 parts by weight, and is selected from the group consisting of polyoxyethylene ethers, alcoholic ethers, acetates, acrylic acids, acrylate esters, phenyl methyl ketones and hydroxyl groups.

7. The composition of claim 3, wherein the solvent is selected from the group consisting of ethers, lower alcohols, propylene glycols, alcoholic ethers and hydroxy acids.

8. The composition of claim 1, wherein the weight-average molecular weight of the water-soluble polymer is 12500-125000.

9. The composition of claim 8, wherein the crosslinking agent is 0.1-10 parts by weight based on 100 parts by weight of the water-soluble polymer.

10. The composition of claim 8, further comprising an additive selected from the group consisting of surfactant, defoaming agent, levelling agent and solvent.

11. The composition of claim 1, wherein a molecular structure of the water-soluble polymer comprises a hydrophilic group selected from the group consisting of hydroxyl group, oxyethyl group, amide group, amino group, sulfo group, sulfinic acid group, carboxyl group and carbonyl group.

12. The composition of claim 11, wherein the crosslinking agent is 0.1-10 parts by weight based on 100 parts by weight of the water-soluble polymer.

13. The composition of claim 11, further comprising an additive selected from the group consisting of surfactant, defoaming agent, levelling agent and solvent.

14. The composition of claim 1, wherein the crosslinking agent is glutaraldehyde.

15. The composition of claim 14, wherein the crosslinking agent is 0.1-10 parts by weight based on 100 parts by weight of the water-soluble polymer.

16. The composition of claim 14, further comprising an additive selected from the group consisting of surfactant, defoaming agent, levelling agent and solvent.

17. The composition of claim 1, wherein the crosslinking agent is selected from the group consisting of isocyanate-based crosslinking agent, melamine-based crosslinking agent, epoxy-based crosslinking agent, acrylate-based crosslinking agent or methacrylate comprising isocyanate-group.

18. A protective sheet for laser dicing, comprising:
a substrate, and
a protective layer formed of the protective film composition for laser dicing of claim 1 coated on the substrate, and wherein a thickness of the protective layer ranges from 100 to 50000 nm.
